(19) United States
(12) Patent Application Publication
(10) Pub. No.: US 2025/0392487 A1
(43) Pub. Date: Dec. 25, 2025

(54) COMMUNICATION DEVICE

(71) Applicant: TOYOTA JIDOSHA KABUSHIKI KAISHA, Toyota-shi (JP)

(72) Inventors: Koji TAKEOKA, Tokyo (JP); Akira ITO, Ichikawa-shi (JP)

(73) Assignee: TOYOTA JIDOSHA KABUSHIKI KAISHA, Toyota-shi (JP)

(21) Appl. No.: 19/236,235

(22) Filed: Jun. 12, 2025

(30) Foreign Application Priority Data
Jun. 25, 2024 (JP) 2024-102033

(51) Int. Cl. H04L 12/14; H04L 45/12; H04L 45/24; H04L 69/22

(52) U.S. Cl. CPC H04L 12/1403; H04L 45/123; H04L 45/24; H04L 69/22

(57) ABSTRACT

A communication device that is capable of receiving packets via one of a first route, in which a service provider bears usage fees, and a second route, in which a user bears usage fees, the communication device comprises: a controller configured to execute: acquire information indicating use of the first route and log information, in a case where the packet is from the first route; acquire the log information, in a case where the packet is from the second route; identify whether the packet passed through the first route or the second route based on whether the information was acquired together with the log information; identify whether the packet is related to the service provider or the user, based on header information; and generate information indicating an incentive to the user, in a case where the packet is received via the second route and is related to the service provider.

### CROSS REFERENCE TO THE RELATED APPLICATION

This application claims the benefit of Japanese Patent Application No. 2024-102033, filed on Jun. 25, 2024, which is hereby incorporated by reference herein in its entirety.

### BACKGROUND

### Technical Field The present disclosure relates to a communication device.

### Description of the Related Art

Conventionally, there are communication devices equipped with a Subscriber Identity Module (SIM) card capable of storing a plurality of communication profiles (for example, Japanese Patent Application Laid-Open Publication No. 2022-180105A).

### SUMMARY

An object of the present disclosure is to provide a communication device that enables a service provider to give an incentive to a user for using a communication infrastructure for which the user bears a usage fee.

The present disclosure in its one aspect provides a communication device that is capable of receiving packets from a source device via one of a first route, in which a service provider that provides a service to a user bears usage fees, and a second route, in which the user bears usage fees, the communication device comprising: a controller configured to execute: acquire information indicating use of the first route and log information concerning to transmission of a packet, in a case where the packet is received via the first route; acquire the log information, in a case where the packet is received via the second route; identify whether the packet passed through the first route or the second route based on whether the information was acquired together with the log information; identify whether the packet is related to the service provider or the user, based on header information attached to the packet; and generate information indicating an incentive provided by the service provider to the user, in a case where the packet is received via the second route and is related to the service provider.

The present disclosure in its another aspect provides a communication device that is capable of receiving packets from a source device via one of a first route in which a service provider that provides a service to a user bears usage fees and a second route in which the user bears usage fees, the communication device comprising: a controller configured to execute: acquire first information indicating use of the first route and log information concerning to transmission of a packet, in a case where the packet is received via the first route; acquire second information indicating use of the second route and the log information, in a case where the packet is received via the second route; identify whether the packet passed through the first route or the second route, based on which one of the first information and the second information has been acquired; identify whether the packet is related to the service provider or the user, based on header information attached to the packet; and generate information indicating an incentive provided by the service provider to the user, in a case where the packet is received via the second route and is related to the service provider.

According to the present disclosure, it becomes possible to provide incentives to users with regard to the use by service providers of communication infrastructure for which users are required to pay a usage fee.

### BRIEF DESCRIPTION OF THE DRAWINGS

FIG. 1 is a diagram illustrating an example of a communication system according to an embodiment.

FIG. 2 is a diagram showing an example of the configuration of the in-vehicle device 10. As shown in FIG.

FIG. 3 shows an example of the configuration of the communication device 20.

FIG. 4 is a sequence diagram showing an example of the operation of the communication system.

FIG. 5 is a flowchart showing an example of processing in the controller 25.

FIG. 6 is a flow chart showing a modified example.

### DESCRIPTION OF THE EMBODIMENTS

Business operators of vehicles equipped with communication functions, such as connected cars and autonomous vehicles (e.g., vehicle manufacturers, dealers, rental companies, etc.) may wish to collect data related to the vehicles (e.g., data related to the operation of the vehicle, data related to vehicle communications, etc.).

For this reason, it is considered that a communication device (communication equipment) of an operator receives, via a network, predetermined data (IoT data) transmitted from an in-vehicle device installed in a vehicle. Then, as a service provider, the business operator can provide services to vehicle users based on the analysis results of the IoT data.

As a network connecting vehicles and communication devices, for example, a network (called a communication carrier network) of a mobile network operator (MNO: also called a communication carrier) with which an operator has a contract may be used. However, the vehicle and the communication device may also be connected by tethering using a user's smartphone. The communication device according to the present disclosure enables an operator (service provider) to provide an incentive to a user when the operator transmits data (packets) using a communication infrastructure that the user can use (for which the operator pays the usage fee).

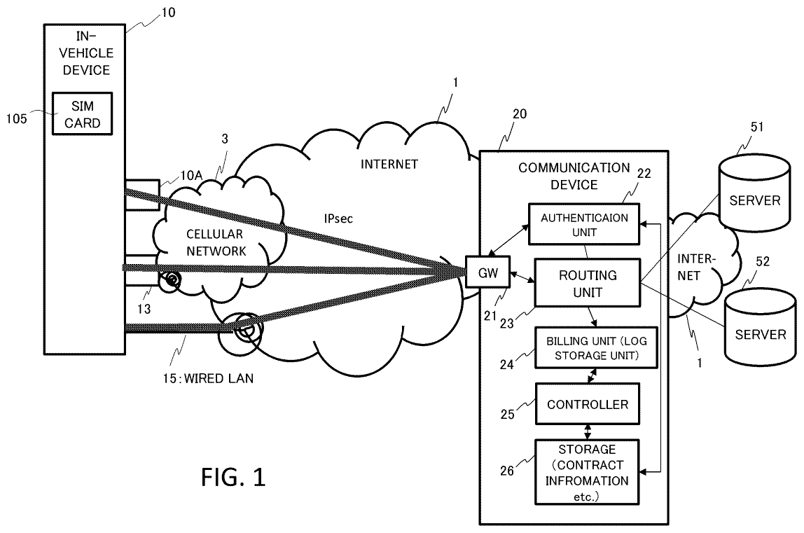

Hereinafter, embodiments of the present disclosure will be described with reference to the drawings. The configurations of the following embodiments are merely examples, and the present disclosure is not limited to the configurations of the embodiments. FIG. 1 is a diagram illustrating an example of a communication system according to an embodiment. The communication system includes an in-vehicle device 10 (corresponding to a communication device) mounted in a vehicle, and a communication device 20. The in-vehicle device 10 may be of a type installed on a vehicle or of a type that is portable.

The vehicle is a connected vehicle that has the function of communicating with the communication device 20 and providing a predetermined service to the user of the vehicle. The vehicle can provide various services by communicating with a server apparatus (for example, server 51 or server 52) connected to the communication device 20. Examples of various services include navigation services, remote control services (e.g., remote air conditioning), in-vehicle Wi-Fi services, and emergency reporting services. These services may be provided by the in-vehicle device 10 or by another computer installed in the vehicle.

The in-vehicle device 10 is connected to a plurality of ECUs mounted on the vehicle. Each ECU can collect various information such as information about the vehicle (data related to driving of the vehicle, such as the position, vehicle speed, etc.) by executing a predetermined application program. The correspondence between ECUs and apps is, for example, 1:1, but two or more ECUs may use the same app, such as n:1, or one ECU may execute two or more types of apps, such as 1:n. Furthermore, the in-vehicle device 10 can execute the same type of application as the application executed by the ECU. Furthermore, the in-vehicle device 10 may execute an application other than the application for collecting information related to the vehicle, thereby allowing the user to browse the web or enjoy music, images, or videos.

Data transmitted from the in-vehicle device 10 is sent to a predetermined destination (a communication partner, for example, a server 51 or 52) via an IP (Internet Protocol) network and the communication device 20. The destination of the data may be the communication device 20. As the IP network, for example, a public network such as the Internet 1 can be used, but the IP network may be other than the Internet 1.

The in-vehicle device 10 can be connected to the Internet 1 in various forms and communicate with the communication device 20. For example, the in-vehicle device 10 can connect to the Internet 1 via the cellular network 3 using a communication device 10A such as a smart device or a cellular USB dongle 13. In the example shown in FIG. 1, the communication device 10A and the USB dongle 13 are connected to the same cellular network 3, but due to differences in telecommunications carriers, the cellular network to which the communication device 10A can be connected may be different from the cellular network to which the USB dongle 13 can be connected. In addition, the in-vehicle device 10 can be connected to the Internet 1 via a wireless LAN (including Wi-Fi) access point. The in-vehicle device 10 can also be connected to the Internet via a router of the wired LAN 15. The in-vehicle device 10 can also connect to the Internet 1 using a USB dongle for wireless LAN or satellite communication.

The administrator (the person who enters into a line contract and pays the usage fees) of the communication device 10A, the USB dongle 13, the wireless LAN access point, and the wired LAN 15 router may be a business operator (service provider), a user, or a third party other than the business operator or user.

When communicating with the communication device 20, the in-vehicle device 10 performs mutual authentication using profile information stored in the SIM card 105 of the in-vehicle device 10. The SIM card 105 is, for example, a SIM card issued by a carrier (service provider). The cellular network 3 may be a Mobile Network Operator (MNO) network or a Mobile Virtual Network Operator (MVNO) network. The cellular network 3 is, for example, an LTE network or a 5G network, but may be another network (for example, a 6G network).

The communication device 10A is, for example, a smart device. The smart device may be a smartphone or a tablet terminal having a SIM card. The connection between the in-vehicle device 10 and the smart device may be a wireless connection using a wireless LAN (including Wi-Fi), a wireless connection using Bluetooth (registered trademark), or a wired connection using a USB (Universal Serial Bus) cable.

The communication device 20 is configured by one information processing apparatus (computer) or a collection (cloud) of two or more information processing apparatus connected via a network. The communication device 20 has an internal network configuration formed by a collection of components of a core network of a cellular network (network nodes, called network functions (NFs) in 5G) according to the use or function of the communication device 20. In the example shown in FIG. 1, the communication device 20 operates as a device including a gateway (GW) 21, an authentication unit 22, a routing unit 23, a billing unit (log storage unit) 24, a controller 25, and a storage 26.

The GW 21 is connected to the in-vehicle device 10 via an access network and the Internet 1 (IP network). When the internal network configuration of the communication device 20 is a 5G core network (5GC), an N3IWF (non-3GPP Interworking Function) is deployed as the GW 21. The N3IWF is a gateway for accommodating untrusted non-3GPP wireless access. When the internal network configuration of the communication device 20 is an LTE or 4G core network (EPC), an ePDG (enhanced Packet Data Gateway) is used as the GW 21. An IPsec-based tunnel (called an SWu tunnel) is established between the in-vehicle device 10 and the GW 21, and data sent from the in-vehicle device 10 is transmitted to the GW 21 through the SWu tunnel.

When the in-vehicle device 10 accesses the communication device 20, the in-vehicle device 10 transmits SIM profile information stored in the SIM card 105 to the communication device 20 as authentication data (control information). The authentication unit 22 can authenticate the in-vehicle device 10 having the SIM card 105 by using the SIM profile information and the subscriber information stored in the storage 26.

For example, when the internal network configuration of the communication device 20 is 5GC, an Authentication Server Function (AUSF) may be used as the authentication unit 22, and a Unified Data Management (UDM) may be used as the storage 26. When the internal network configuration is EPC, an AAA (Authentication, Authorization, Accounting) may be used as the authentication unit 22, and an HSS (Home Subscriber Server) may be used as the storage 26.

The routing unit 23 performs the following routing. In other words, when the routing unit receives a packet containing user data, it determines whether the destination IP address of the packet is registered in the routing table, and if it is not registered, it calculates the shortest route to the destination IP address using an SPF or the like, determines information indicating the route (output port) according to the shortest route, and performs a process of registering the destination IP address and output port information in the routing table. Furthermore, the routing unit 23 performs a process of forwarding a packet whose destination IP address is registered in the routing table to the corresponding output port (destination). For example, when the internal network configuration of the communication device 20 is 5GC, a UPF (User Plane Function) may be used as the routing unit 23, and when the internal network configuration is EPC, a P-GW (Packet data network Gateway) may be used as the routing unit 23. A GTPu tunnel is formed between the GW 21 and the routing unit 23 (UPF or P-GW), and the GW 21 sends a packet obtained by terminating the SWu tunnel to the routing unit 23 through the GTPu tunnel.

Furthermore, the routing unit 23 outputs a CDR (Charge Data Record) used as billing information, and passes it to the billing unit 24. The CDR is communication log information (log information) that may include packet flow identification information (e.g., source/destination TCP port numbers, source/destination IP addresses), start and end times of the packet flow, and data volume. For example, when the internal network configuration of the communication device 20 is 5GC, a CHF (Charging Function) is used as the billing unit 24, and when the internal network configuration is EPC, a PCRF (Policy and Charging rules Function) is used as the billing unit 24. The billing unit 24 calculates the usage fee for packet communication using the CDR. The usage fee is calculated based on, for example, the amount of data per packet and the fee plan.

When a communication device 10A or a cellular USB dongle 13, for which a carrier or a third party pays the usage fee (a line contract has been concluded), is used to connect to the Internet 1, and the in-vehicle device 10 is connected to the Internet 1 (communication device 20) via the cellular network 3, the CDR (log information) includes an IMSI (International Mobile Subscription Identity) stored in a SIM card possessed by the communication device 10A or the cellular USB dongle 13. For example, the cellular network 3 and the communication device 20 share a conversion table between IMSIs and line identifiers (which may be configurable as one or more bit strings, for example) for operators and third parties. The line identifier may be represented, for example, by one or more bits. The cellular network 3 converts the IMSI into a line identifier using a conversion table, and transmits it to the communication device 20. The line identifier is transmitted separately from the packet transmitted from the in-vehicle device 10 to the communication device 20. The communication device 20 converts the line identifier into an IMSI using a conversion table. The IMSI is sent to a routing unit 23, which generates a CDR including the IMSI. The locations where the conversion table and the conversion mechanism are implemented in the cellular network 3 and the communication device 20 can be set appropriately. Additionally, the line identifier may be transmitted either online or offline. The conversion table registers the IMSI (the IMSI of the operator or a third party) stored in a SIM card mounted on communication device 10A or cellular USB dongle 13 owned by a operator or a third party (who pays the usage fee), but does not register the IMSI stored in a SIM card mounted on communication device 10A or cellular USB dongle 13 owned by a user (who pays the usage fee). Therefore, when the user's communication device 10A or cellular USB dongle 13 is used, the line identifier is not communicated to the communication device 20 and the IMSI is not included in the CDR.

The controller 25 uses the CDR (log information) to perform a process of identifying the route (communication infrastructure) used to forward the packet. In addition, the controller 25 performs a process of identifying the user of the identified communication infrastructure (packet) by using the header information (port number) of the packet. Then, when the identified combination of the communication infrastructure and the user indicates a specific combination, the controller 25 generates information indicating an incentive to be given to the user in the specific combination (information indicating an action toward the user).

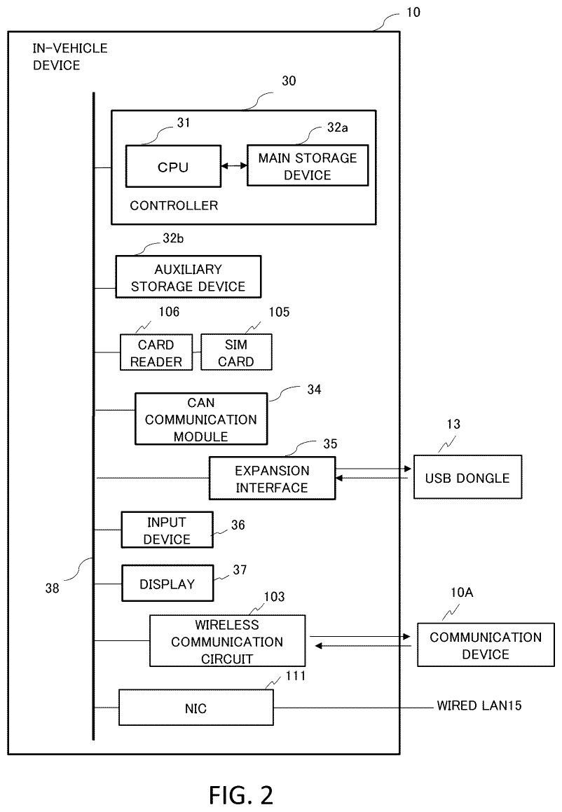

FIG. 2 is a diagram showing an example of the configuration of the in-vehicle device 10. As shown in FIG. The in-vehicle device 10 includes a controller 30 having a CPU 31 and a main storage device 32a, an auxiliary storage device 32b, a SIM card 105 and its card reader 106, a CAN communication module 34, an expansion interface 35, a wireless communication circuit 103, and a network interface card (NIC) 111, all of which are interconnected via a bus 38.

The auxiliary storage device 32b is, for example, a hard disk drive (HDD), a solid state drive (SSD), an EEPROM, or the like. The auxiliary storage device 32b stores, for example, an OS (Operating System) and a plurality of types of application programs (apps). The application includes programs for implementing various functions, such as a communication control program. The main storage device 32a is, for example, a random access memory (RAM), a read only memory (ROM), or a combination of a RAM and a ROM. The primary storage device and the secondary storage device are examples of computer-readable non-transitory recording media. The CPU 31 operates as the in-vehicle device 10 by executing various programs stored in the main storage device 32a or the auxiliary storage device 32b.

The SIM card 105 is a UICC (universal integrated circuit card) and operates as a microcomputer having a CPU and a memory. The UICC may be a card type (UICC) or a chip type (eUICC). The SIM card 105 stores profile information used for authentication. The profile information includes an identification number and key information. The identification number is, for example, an International Mobile Subscription Identity (IMSI), a Mobile Subscriber Integrated Services Digital Network Number (MSISDN), or an Integrated Circuit Card IDentity (ICCID). The key information includes the K value used in AKA authentication, OPc (operator code), and SQN (sequence number). For example, in authentication using the SIM card 105, profile information including at least the IMSI, K value, OPc, and SQN is used. Incidentally, the SIM card 105 may be a UICC card type (UICC) or a chip type (eUICC). In other words, the SIM card 105 may be a physical SIM card or an eSIM.

The CAN communication module 34 is a communication interface for connecting the in-vehicle device 10 to an in-vehicle network (CAN (Controller Area Network)) of the vehicle. The CAN communication module 34 may include, for example, a network interface board that communicates according to the CAN protocol. The in-vehicle device 10 can perform data communication with other components (such as an ECU) of the vehicle via the CAN communication module 34.

The expansion interface 35 is an interface for connecting the in-vehicle device 10 to the communication device 10A or the USB dongle 13. The expansion interface 35 is, for example, a USB (Universal Serial Bus) interface, and has a USB cable connected to the communication device 10A or a connector to which the USB dongle 13 can be detached. The communication device 10A can be detachably connected to the expansion interface 35 via a USB cable connected to a connector.

The wireless communication circuit 103 includes DCE (Data Circuit terminating Equipment) and can perform wireless communication with external devices according to wireless communication methods such as cellular networks (LTE, 5G, or 6G, etc.), Bluetooth (registered trademark), and wireless LAN (IEEE 802.11 series, including Wi-Fi). For example, the wireless communication circuit 103 can be connected to a base station of the cellular network 3A. Furthermore, the wireless communication circuit 103 can be connected to the communication device 10A and the like via a wireless LAN or Bluetooth (registered trademark). The NIC 111 is used to connect the in-vehicle device 10 to the Internet 1 via the wired LAN 15. The in-vehicle device 10 may further include, as optional components, an input device 36 for inputting information and a display 37 for displaying information.

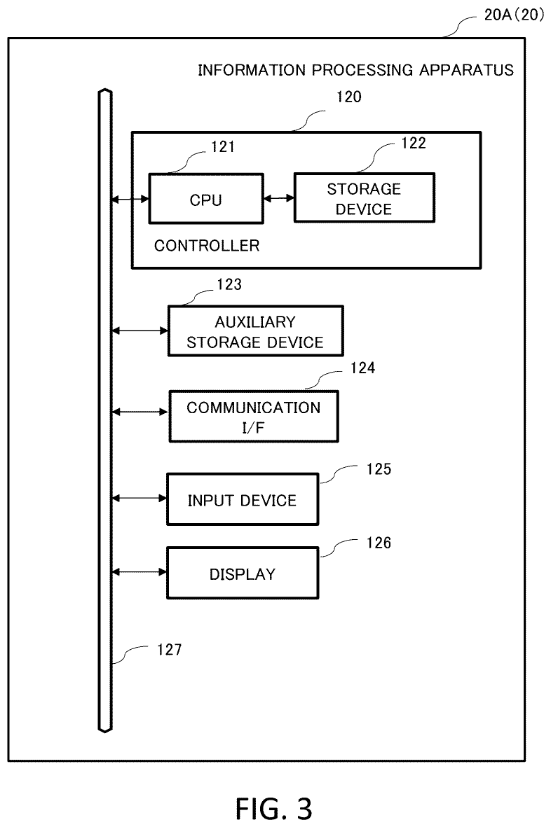

FIG. 3 shows an example of the configuration of an information processing apparatus 20A that can be used as the communication device 20. As shown in FIG. The communication device 20 may be composed of one or more information processing apparatus 20A. 3, the information processing apparatus 20A includes a controller (controller) 120, an auxiliary storage device 123, a communication interface (communication IF) 124, an input device 125, and a display 126, which are interconnected by a bus 127.

The controller 120 includes a CPU 121 and a main storage device 122 connected to the CPU 121. By executing various programs stored in the main storage device 122 or the auxiliary storage device 123, the CPU 121 causes the communication device 20 to operate as a device including a GW 21, an authentication unit 22, a routing unit 23, a billing unit (log storage unit) 24, a controller 25, and a storage 26.

A communication interface (communication IF) 124 includes a communication interface circuit with the Internet 1 (IP network), and transmits and receives control information and user data (packets), converts formats (protocols), and so on. The input device 125 includes buttons, keys, a touch panel, and the like used for inputting and setting information. The display 126 is used to display information. The input device 125 and display 126 are optional.

The CPU (processor) constituting each of the controllers 30 and 120 described above may be a processor other than a CPU, such as a DSP or GPU, or may be combined with a CPU. In addition, the processing or operations performed by each of the controllers 30, 100, and 120 may be performed using a semiconductor device (hardware) such as an FPGA (Field Programmable Gate Array) or an ASIC (Application Specific Integrated Circuit), or may be a combination of a processor and hardware such as a SoC (System On a Chip). Each of the controller, FPGA, ASIC, and SoC is an example of a “circuitry.”

### Example of Operation

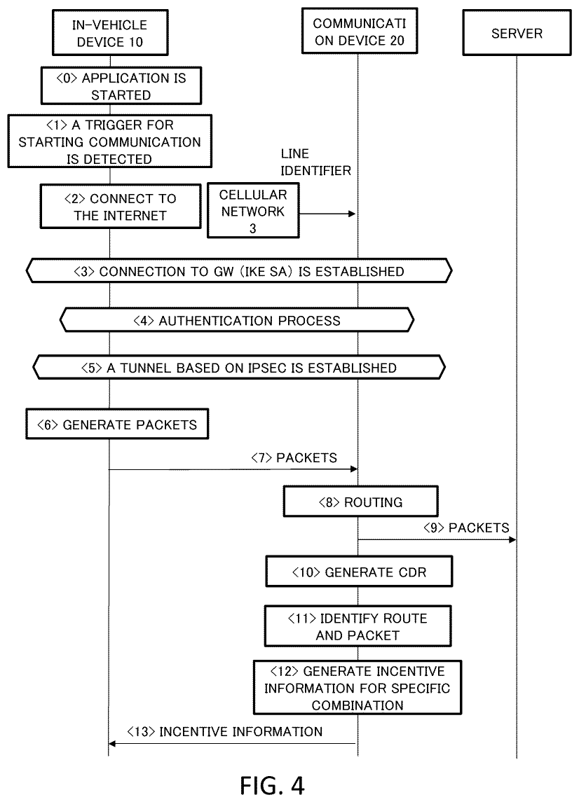

FIG. 4 is a sequence diagram showing an example of an operation in the communication system. At <0> in FIG. 4, an application for communicating with the communication device 20 is started in the in-vehicle device 10. The in-vehicle device 10 has installed therein an application for a business operator, an application for a user, and an application for a third party (for example, an insurance company of the vehicle, etc.). These applications may be configured to be automatically started based on a preset setting such as a timer setting, or may be configured so that an operator manually starts any application. The execution subject of the app may be an ECU provided in the vehicle or the in-vehicle device 10.

In <1> of FIG. 4, the controller 30 of the in-vehicle device 10 detects a trigger for starting communication. The trigger can be set as appropriate and may be, for example, the generation of data to be transmitted by the execution of an app, the detection of an instruction to start communication for stored data entered from the input device 36, or the detection of the occurrence of some other event other than those mentioned above.

In <2> of FIG. 4, the in-vehicle device 10 connects to the Internet 1. The in-vehicle device 10 can connect to the Internet 1 using a communication device 10A, a USB dongle 13, a wired LAN 15, or the like. In the first operation example, as an example, the communication device 10A and the cellular USB dongle 13 can be used for which the operator, user, or a third party pays the usage fees (a line contract has been concluded), and the USB dongle for wireless LAN or satellite communication and the wired LAN 15 are used for which the user pays the usage fees. When a carrier or third party's communication device 10A or a cellular USB dongle 13 is used, a line identifier converted from the IMSI is transmitted from the cellular network 3 to the communication device 20 (see FIG. 4).

In <3> of FIG. 4, the in-vehicle device 10 establishes an encrypted communication path (IKE SA) called a security association (SA) between the in-vehicle device 10 and the GW 21 of the communication device 20. The IP address of the GW 21 is already known to the in-vehicle device 10.

In <4> of FIG. 4, an authentication process (for example, authentication using AKA) is performed between the in-vehicle device 10 and the communication device 20 using the profile information (authentication data) stored in the SIM card 105.

In <5> of FIG. 4, a tunnel based on IPsec is established. That is, an SWu tunnel is established between the in-vehicle device 10 and the GW 21, and a GTPu tunnel is established between the GW 21 and the routing unit 23.

In <6> of FIG. 4, the in-vehicle device 10 generates packets storing the data to be transmitted, and transmits the packets to the GW 21 of the communication device 20 through the SWu tunnel (<7> of FIG. 4). The SWu tunnel is terminated at GW 21, the SWu header is removed, and the original packet is obtained. The GW 21 adds a new header (called a GTPu header) to the packet in order to transmit the packet through the GTPu tunnel established between the GW 21 and the routing unit 23.

The routing unit 23 performs termination processing of the GTPu tunnel (removal of the GTPu header, etc.) on the packet received from the GW 21 to obtain the original packet. The routing unit 23 performs routing for the original packet (<8> in FIG. 4). The packet is sent to the destination by routing (<9> in FIG. 4).

The routing unit 23 generates a CDR (Charging Data Record) including information on the packet flow, such as the source and destination IP addresses of the original packet, the source and destination TCP port numbers, the start and end times of the packet flow, and the amount of data in the packet (<10> in FIG. 4). At this time, if the routing unit 23 has received a line identifier from the GW 21 or the like, it uses a conversion table to convert the line identifier into an IMSI (the IMSI stored in the SIM card 105) and includes the IMSI in the CDR. The CDR is passed to the billing unit 24. The billing unit 24 calculates the usage fee using the CDR.

The controller 25 acquires the CDR from the billing unit 24, and identifies the route along which the packet has been transferred and the user of the packet (<11> in FIG. 4). The controller 25 generates incentive information (information indicating an action for a user) when a combination of a route and a user of a packet is a specific combination (<12> in FIG. 4).

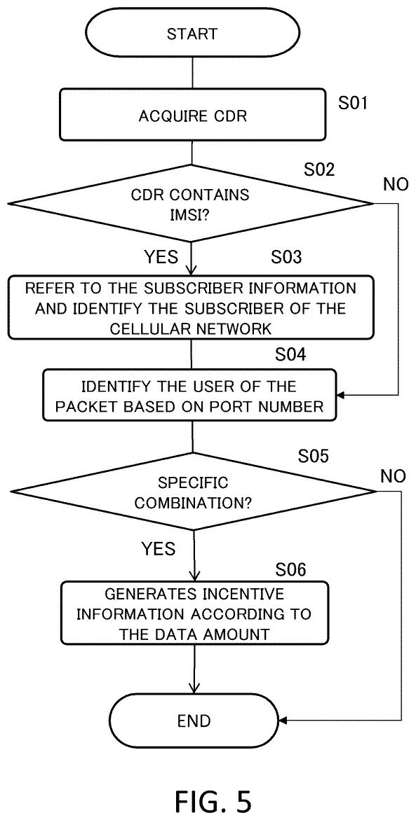

FIG. 5 is a flowchart showing an example of processing by the controller 25, and shows details of <11> and <12> in FIG. 4. In step S01, the controller 25 acquires the CDR passed from the routing unit 23 to the billing unit 24. However, the CDR may be directly passed from the routing unit 23 to the controller 25.

In step S02, if the controller 25 determines that the CDR contains the IMSI of the SIM card, the process proceeds to step S03, and if not, the process proceeds to step S04. The fact that the CDR contains the IMSI of the SIM card means that the packet was received via a route using the communication device 10A or cellular USB dongle 13 owned by the carrier or a third party. On the other hand, if the CDR does not contain the IMSI of the SIM card, this means that the packet was received via a route for which the user pays.

In step S03, the controller 25 refers to the subscriber information (contract information of at least one of the operator and a third party) stored in the storage 26, and determines whether the IMSI included in the CDR is the IMSI of the operator or a third party, thereby identifying the subscriber of the cellular network 3. If the IMSI is the operator's IMSI, it means that the packet was received via a route for which the operator pays the usage fees; if not, it means that the packet was received via a route for which a third party pays the usage fees.

In this way, steps S02 and S03 make it possible to determine (identify) whether the route taken by the packet is a route for which the operator pays the usage fee (first route), a route for which the user pays the usage fee (second route), or a route for which a third party pays the usage fee (third route).

In step S04, the controller 25 identifies the user of the packet from the port number included in the CDR. That is, based on the port number, if the packet is a packet for an operator (a packet related to an operator), the controller 25 determines that the user of the packet is the operator; if the packet is a packet for a user (a packet related to a user), the controller 25 determines that the user of the packet is the user; and if the packet is a packet for a third party (a packet related to a third party), the controller 25 determines that the user of the packet is a third party.

In step S05, the controller 25 determines whether or not the route and the user of the packet are a specific combination. Here, the combinations of routes (communication infrastructure providers) and packet users are as follows: Route (communication infrastructure provider)/packet user: (1) operator/operator, (2) operator/user, (3) operator/third party, (4) user/user, (5) user/operator, (6) user/third party, (7) third party/third party, (8) third party/operator, (9) third party/user.

In this embodiment, the specific combination is the combination of (5) and (8). That is, the specific combination is a case where a packet from a carrier is transferred via a route (communication infrastructure) of a user or a third party (the user pays the packet fee). However, combination (8) is optional. In addition, combinations other than the above-mentioned (5) and (8) may be set as specific combinations.

In step S06, the controller 25 generates incentive information according to the data amount of the packet included in the CDR (the content of the incentive information changes according to the data amount). For example, when calculating the amount of data for which a user will be charged, after completing packet transmission, the communication device 20 can inquire the number of packets (amount of data) from the cellular network 3 using the line identifier as an argument, and obtain the amount of data as a response. The communication device 20 can then reflect this data volume in the content of the incentive. However, the content of the incentive information may be fixed regardless of the amount of data. The content of the incentive is arbitrary and may be points, coupons, gift certificates, cash back, or some other preferential treatment that can be used to purchase products or services, but is not limited to these examples. Also, instead of incentive information, information indicating an action other than the granting of an incentive may be generated.

The generated incentive information is stored, for example, in the storage 26 and is used as information indicating the basis for the business operator to give some kind of incentive to the user. For example, data such as a coupon based on the incentive information may be transmitted to the in-vehicle device 10 (<13> in FIG. 4). The method of granting the incentive is arbitrary. In the embodiment, the controller 25 acquires a CDR including an IMSI (the IMSI is included in the CDR), but the controller 25 may acquire the CDR and the IMSI separately. In addition, in the embodiment, an example was shown in which the communication device 20 converts the line identifier into an IMSI using a conversion table, but if the line identifier indicates whether the route taken by the packet is the first route or the third route, conversion to IMSI is not necessary.

In the embodiment, the communication device 20 is capable of receiving packets from a sending device (vehicle device 10) via either a first route, the usage fee of which is borne by a service provider (business operator) that provides a service to a user, or a second route, the usage fee of which is borne by the user. When a packet is received via the first route, the controller 25 of the communication device 20 obtains information indicating that the packet used the first route (IMSI) and log information related to the transmission of the packet (CDR). Furthermore, when a packet is received via the second route, the controller 25 acquires log information (CDR) (without acquiring the IMSI). The controller 25 can identify whether the route taken by the packet is the first route or the second route, depending on whether the IMSI is acquired along with the log information. The controller 25 can identify whether a packet is related to a service provider or a user based on the header information (port number) added to the packet. Then, the controller 25 can generate information indicating an incentive that the service provider will give to the user when the packet is a packet related to the service provider and received via the second route. In this manner, the communication device 20 generates information indicating an incentive that the operator will give to the user when a packet carrying data for the operator is transmitted using a communication infrastructure for which the user pays. This makes it possible to give incentives to users regarding the service provider's use of their communications infrastructure.

Furthermore, the communication device 20 according to the embodiment may be capable of receiving packets from the in-vehicle device 10 via a third route, the usage fee of which is paid by a third party other than the service provider (business operator) and the user. In this case, when the IMSI is acquired along with the log information, the controller 25 can determine that the route taken by the packet is the first route or the third route. Also, based on the IMSI, it is possible to identify whether the route taken by the packet is the first route or the third route. Furthermore, the controller 25 can identify whether the packet is for the service provider, the user, or a third party, based on the port number of the packet. Then, the controller 25 can generate information indicating an incentive given by the service provider to a third party when the packet is a packet related to the service provider received via the third route. In this way, the service provider can provide an incentive to a third party such as an insurance company.

### Modification

The above-described embodiment can be modified as described below. That is, in the modified example, each of the operators, users, and third parties can connect to the Internet 1 (communication device 20) using a communication device 10A, a USB dongle (for cellular, wireless LAN, and satellite communication), and a wired LAN 15, for which the operators, users, and third parties pay the usage fees.

In a modified example, a line identifier obtained by converting the IMSI of an operator, user, or third party using a conversion table is transmitted to communication device 20 from a cellular network or satellite communication network through which the packet passes. In addition, the communication equipment that constitutes the wired LAN 15 or the information processing apparatus that manages (controls) the wired LAN 15 monitors packets sent from the in-vehicle device 10, and when a corresponding packet is detected, the line identifier is transmitted to the communication device 20. In addition, a communication device (access point) that constitutes the wireless LAN, or an information processing apparatus that manages (controls) the wireless LAN monitors packets transmitted from the in-vehicle device 10, and when a corresponding packet is detected, the line identifier is transmitted to the communication device 20.

The line identifier in the modified example is information indicating whether the packet has passed through the first route, the second route, or the third route described in the embodiment, and no conversion is performed using a conversion table in the communication device 20.

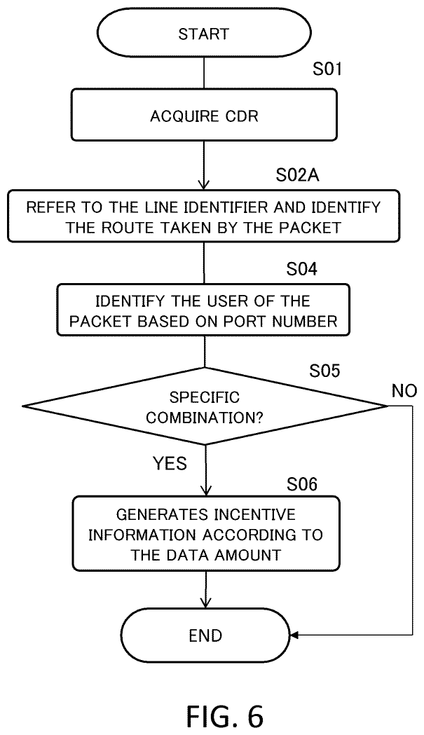

FIG. 6 is a flowchart showing an example of processing in the second operation example, in which step S02A is provided instead of steps S02 and S03 shown in FIG. In step S01 of FIG. 6, the communication device 20 (the controller 30 thereof) acquires a CDR including a line identifier. However, the CDR and the line identifier may be obtained separately.

In step S02A, the communication device 20 (controller 30 thereof) refers to the value of the line identifier and identifies (identifies) whether the route taken by the packet is the first route, the second route, or the third route. Step S04 and subsequent steps are the same as those in FIG. 5, and therefore the description thereof will be omitted.

In a variant example, a line identifier indicating whether the route taken by the packet is the first route, the second route, or the third route is transmitted to communication device 20 from a communication device on the route taken by the packet, or from a management device (control device) of the communication device. This allows the route of the packet to be identified. A line identifier indicating that the route taken by the packet is a first route is an example of first information, a line identifier indicating that the route taken by the packet is a second route is an example of second information, and a line identifier indicating that the route taken by the packet is a third route is an example of third information.

The processes and means described in this disclosure can be freely combined and implemented as long as no technical contradiction occurs. Furthermore, the processes described as being performed by one device may be shared and executed by a plurality of devices. Alternatively, the processes described as being performed by different devices may be performed by a single device. In a computer system, the hardware configuration for implementing each function can be flexibly changed. The present disclosure can also be realized by supplying a computer program implementing the functions described in the above embodiments to a computer, and having one or more processors of the computer read and execute the program. Such a computer program may be provided to the computer by a non-transitory computer-readable storage medium connectable to the system bus of the computer, or may be provided to the computer via a network.

What is claimed is:

1. A communication device that is capable of receiving packets from a source device via one of a first route, in which a service provider that provides a service to a user bears usage fees, and a second route, in which the user bears usage fees, the communication device comprising:
a controller configured to execute:
acquire information indicating use of the first route and log information concerning to transmission of a packet, in a case where the packet is received via the first route;
acquire the log information, in a case where the packet is received via the second route;
identify whether the packet passed through the first route or the second route based on whether the information was acquired together with the log information;
identify whether the packet is related to the service provider or the user, based on header information attached to the packet; and
generate information indicating an incentive provided by the service provider to the user, in a case where the packet is received via the second route and is related to the service provider.

2. The communication device according to claim 1, wherein
the communication device is capable of receiving packets from the source device via a third route in which a third party different from the service provider and the user bears the usage fees;
the controller further executes:
identify whether a route taken by the packet is the first route or the third route, in a case where the information is acquired together with the log information;
identify, based on the information, whether the route taken by the packet is the first route or the third route;
identify, based on the header information of the packet, whether the packet is related to one of the service provider, the user, or the third party; and
generate information indicating the incentive provided by the service provider to the third party, in a case where the packet is a packet related to the service provider and received via the third route.

3. The communication device according to claim 1, wherein
the controller generates information indicating an incentive corresponding to data volume of the packet.

4. The communication device according to claim 1, wherein
the controller identifies whether the packet is related to the service provider or the user, based on port number contained in the header information of the packet.

5. The communication device according to claim 2, wherein
The controller identifies whether the packet is related to the service provider, the user, or a third party, based on port number contained in the header information of the packet.

6. A communication device that is capable of receiving packets from a source device via one of a first route in which a service provider that provides a service to a user bears usage fees and a second route in which the user bears usage fees, the communication device comprising:
a controller configured to execute:
acquire first information indicating use of the first route and log information concerning to transmission of a packet, in a case where the packet is received via the first route;
acquire second information indicating use of the second route and the log information, in a case where the packet is received via the second route;
identify whether the packet passed through the first route or the second route, based on which one of the first information and the second information has been acquired;
identify whether the packet is related to the service provider or the user, based on header information attached to the packet; and
generate information indicating an incentive provided by the service provider to the user, in a case where the packet is received via the second route and is related to the service provider.
